(19) United States
(12) Patent Application Publication
(10) Pub. No.: US 2015/0227383 A1
(43) Pub. Date: Aug. 13, 2015

(54) APPLICATION PROGRAM VIRTUALIZATION SYSTEM AND METHOD OF VIRTUALIZING APPLICATION PROGRAM OF USER TERMINAL

(71) Applicant: ELECTRONICS AND TELECOMMUNICATIONS RESEARCH INSTITUTE, Daejeon (KR)

(72) Inventors: Seung Hyun YOON, Daejeon (KR); Bhum Cheol LEE, Daejeon (KR)

(21) Appl. No.: 14/607,750

(22) Filed: Jan. 28, 2015

(30) Foreign Application Priority Data
Feb. 12, 2014 (KR) 10-2014-0016051

(51) Int. Cl. G06F 9/455

(52) U.S. Cl. CPC G06F 9/45533; G06F 9/455; G06F 9/45558; G06F 2009/45562

(57) ABSTRACT

A system for virtualizing an application program includes: a user terminal including an operating system and a plurality of application programs; and a server configured to generate a virtual machine in response to a request of the user terminal. The user terminal includes a virtual terminal agent configured to transmit first data related to the operating system and second data related to selected one or more application programs to the server, and the server generates and boots a virtual machine based on the first data, and executes the selected one or more application programs in the virtual machine based on the second data.

### CROSS-REFERENCE TO RELATED APPLICATION

This application is based on and claims priority from Korean Patent Application No. 10-2014-0016051, filed on Feb. 12, 2014, with the Korean Intellectual Property Office, the disclosure of which is incorporated herein in its entirety by reference.

### BACKGROUND

1. Field

The present invention relates to a virtualization system, and more particularly, to an application program virtualization system and a method of virtualizing an application program of a user terminal.

2. Discussion of Related Art

Currently, a virtual desktop infrastructure service provides a user with a virtual machine, and is operated by a scheme of providing all of an Operating System (OS), software, and hardware (virtual resource), such as a storage device, for using the virtual machine by a Virtual Desktop Infrastructure (VDI). Accordingly, a function of a user terminal may typically be operated by a scheme of providing only a function (for example, a thin client terminal, a zero client terminal) of relaying a screen image and an input/output device.

In this case, since a user needs to additionally purchase or rent an OS and application program software, as well as a hardware resource driving the virtual machine, existing hardware resources and software resources of the user terminal cannot be used as they are. Accordingly, there is a problem in that a user may not utilize the already possessed resource and software of the terminal.

In the meantime, in a case where the user terminal is a Personal Computer (PC), it is easy to improve insufficient performance through partial upgrade, but in a case where the user terminal is a smart phone, a pad, or a notebook computer, having a difficulty in improving performance of the user terminal through partial upgrade, the whole user terminal needs to be replaced for an application program demanding higher performance, thereby causing a cost problem.

Accordingly, in order to improve performance of a user terminal while maximally utilizing a hardware resource and a software resource of an already possessed user terminal, a method of using a virtual machine, that is, a cloud resource, is demanded.

### SUMMARY

The present invention has been made in an effort to provide an application program virtualization system capable of improving performance of a user terminal while maximally utilizing an operating system and an application program already possessed by the user terminal.

Further, the present invention has been made in an effort to provide a user terminal capable of efficiently utilizing a resource by executing a partial application program in a virtual machine of a server.

Further, the present invention has been made in an effort to provide an application program virtualization method of improving performance of a user terminal while maximally utilizing an operating system and an application program already possessed by the user terminal.

An embodiment of the present invention provides a system for virtualizing an application program, including: a user terminal including an operating system and a plurality of application programs; and a server configured to generate a virtual machine in response to a request of the user terminal. The user terminal includes a virtual terminal agent configured to transmit first data related to the operating system and second data related to selected one or more application programs to the server, and the server generates and boots a virtual machine based on the first data, and executes the selected one or more application programs in the virtual machine based on the second data.

In the exemplary embodiment, the virtual terminal agent may include: a virtual machine management request unit configured to make a request for generation of the virtual machine for executing the selected one or more application programs; a storage device access controller configured to transmit the first data and the second data to the server; an application controller configured to control the application program executed in the virtual machine; an input information processor configured to identify input to be transmitted to the application program executed in the virtual machine and transmit the identified input to the server; and an output processor configured to receive and process an output generated by the application program from the virtual machine of the server.

In the exemplary embodiment, the first data may be execution files of the operating system stored in the storage device of the user terminal, and the server may boot the virtual machine based on the received execution files of the operating system.

In the exemplary embodiment, the first data may be memory information about the operating system loaded in the storage device of the user terminal, and the server may boot the virtual machine based on the received memory information.

In the exemplary embodiment, the virtual terminal agent may further include: a memory monitoring unit configured to detect a changed matter of the memory device of the user terminal; and a memory processor configured to transmit the detected changed matter to the virtual machine of the server.

In the exemplary embodiment, the first data may be identification information about the operating system driven in the user terminal, and the server may boot the virtual machine based on the operating system stored in the server based on the received identification information.

In the exemplary embodiment, the user terminal may further include a display device, and the output processor may display a screen image transmitted from the virtual machine of the server on at least a part of the display device.

In the exemplary embodiment, the virtual terminal agent may transmit the first data to a hypervisor of the server, and the hypervisor boots the virtual machine based on the received first data.

Another exemplary embodiment of the present invention provides a user terminal including: a storage device configured to store an operating system and a plurality of application programs; a virtual terminal agent configured to relay so as for one or more application programs among the plurality of application programs to be executed in a virtual machine of a server; and a display device configured to display an output of an application program executed in the virtual machine, in which the virtual terminal agent transmits first data related to the operating system and second data related to an application program to be executed in the virtual machine to the server.

In the present exemplary embodiment, the user terminal may further include one or more processors configured to execute application programs except for the application program executed in the virtual machine.

Yet another exemplary embodiment of the present invention provides a method of virtualizing an application program of a user terminal, including: transmitting first data related to an operating system stored in the user terminal and second data related to one or more application programs selected from among a plurality of application programs; booting a virtual machine in the server based on the first data; executing the selected one or more application programs in the virtual machine based on the second data; and transmitting input information for driving the executed application program to the server from the user terminal, and transmitting output information output according to the driving of the executed application program to the user terminal from the server.

In the exemplary embodiment, the method may further include displaying the output information transmitted to the user terminal on at least a partial area of a display device of the user terminal.

In the exemplary embodiment, the first data may be execution files of the operating system stored in the storage device of the user terminal, and the server may boot the virtual machine based on the received execution files of the operating system.

In the exemplary embodiment, the first data may be memory information about the operating system loaded in the storage device of the user terminal, and the server may boot the virtual machine based on the received memory information.

In the exemplary embodiment, the first data may be identification information about the operating system driven in the user terminal, and the server may boot the virtual machine based on the operating system stored in the server based on the received identification information.

In the exemplary embodiment, the booting of the virtual machine in the server based on the first data may include: searching an OS database within the server based on the identification information about the operating system; and booting the virtual machine based on a result of the searching of the OS database.

In the exemplary embodiment, when the operating system corresponding to the identification information is stored in the OS database as a result of the searching of the OS database, the server may boot the virtual machine based on the operating system stored in the OS database, and when the operating system corresponding to the identification information is not stored in the OS database as the result of the searching of the OS database, the server may transmit an OS request message to the user terminal. The user terminal may transmit the execution files of the operating system stored in the user terminal to the server in response to the OS request message.

According to the exemplary embodiments of the present invention, a user terminal rents a virtual machine and executes an operating system and application software possessed by the user terminal in the virtual machine, thereby using a cloud computing service for the purpose of improving performance of the user terminal.

According to the exemplary embodiment of the present invention, it is possible to provide the application program virtualization system capable of improving performance of a user terminal while maximally utilizing an existing operating system and application program possessed by the user terminal. Further, it is possible to provide the user terminal and the application program virtualization system capable of efficiently utilizing a resource by executing a part of application programs in a virtual machine of a server.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and advantages of the present invention will become more apparent to those of ordinary skill in the art by describing in detail embodiments thereof with reference to the attached drawings in which:

FIG. 1 is a conceptual diagram illustrating an application program virtualization system according to the present invention;

FIG. 2 is a block diagram illustrating an application program virtualization system according to an exemplary embodiment of the present invention in detail;

FIG. 3 is a block diagram illustrating a virtual terminal agent according to the exemplary embodiment of the present invention;

FIG. 4 is a flowchart illustrating an example of an, application program virtualization method according to the present invention;

FIG. 5 is a flowchart illustrating another example of the application program virtualization method according to the present invention;

FIG. 6 is a flowchart illustrating a step of booting a virtual machine based on an operating system of a user terminal according to an exemplary embodiment of the application program virtualization method according to the present invention;

FIG. 7 is a flowchart illustrating a step of booting a virtual machine based on an operating system of a user terminal according to another exemplary embodiment of the application program virtualization method according to the present invention;

FIG. 8 is a flowchart illustrating a step of booting a virtual machine based on an operating system of a user terminal according to yet another exemplary embodiment of the application program virtualization method according to the present invention;

FIG. 9 is a flowchart illustrating a step of executing an application program on a virtual machine according to an exemplary embodiment of the application program virtualization method according to the present invention;

FIG. 10 is a block diagram illustrating an application program virtualization system according to another exemplary embodiment of the present invention;

FIG. 11 is a block diagram illustrating a virtual terminal agent according to another exemplary embodiment of the present invention;

FIG. 12 is a block diagram illustrating an application program virtualization system according to yet another exemplary embodiment of the present invention;

FIG. 13 is a block diagram illustrating a virtual terminal agent according to yet another exemplary embodiment of the present invention; and

FIG. 14 is a block diagram illustrating a computer system for implementing an exemplary embodiment of the application program virtualization system according to the present invention.

### DETAILED DESCRIPTION

Hereinafter, exemplary embodiments of the present invention will be described in detail with reference to the accompanying drawings. The same reference numbers are used throughout the drawings to refer to the same or like parts. Detailed descriptions of well-known functions and structures incorporated herein may be omitted to avoid obscuring the subject matter of the present invention.

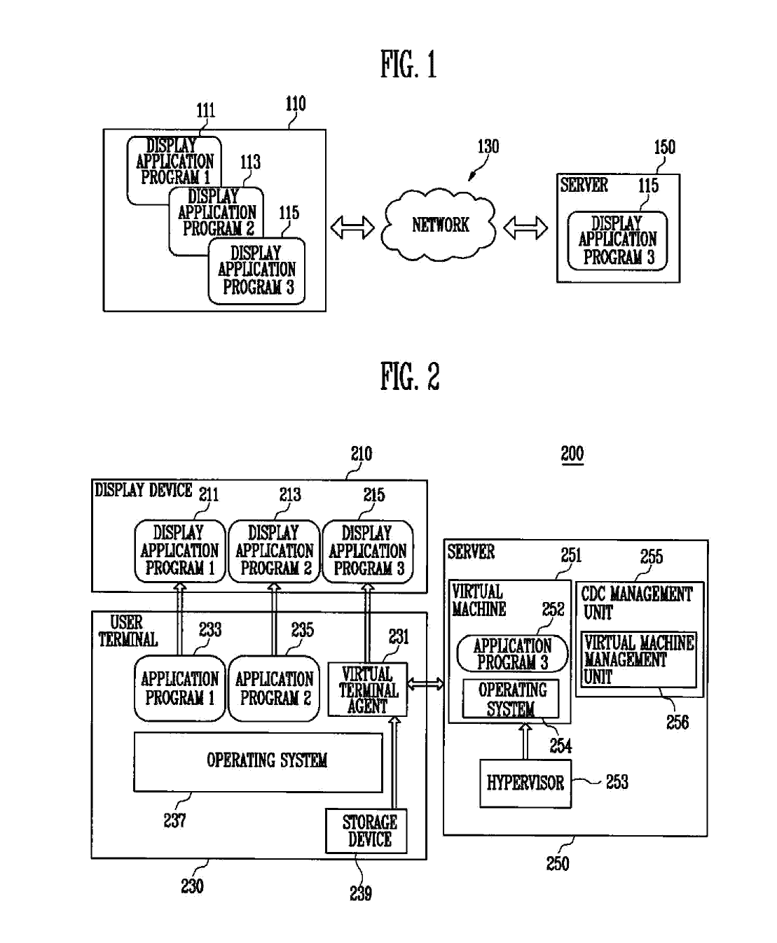

FIG. 1 is a diagram illustrating an application program virtualization system according to the present invention.

Referring to FIG. 1, an application program virtualization system 100 includes a user terminal 100 and a server 150 which are connected with each other by a network 130. The user terminal 110 may execute application 1 111 and application program 2 113. Further, there may be a case in which the user terminal 110 desires to execute application program 3 115 in addition to application 1 111 and application program 2 113. In a case where a hardware resource and the like of the user terminal 110 is insufficient, application program 3 115 may be executed through a cloud service. The server 150 providing the cloud service may receive a request for execution of application program 3 115 from the user terminal 110 through the network 130, and execute application program 3 115 through a virtualization machine of the server 150.

When application program 3 115 is actually operated in the virtual machine of the server 150, the user of the user terminal 110 may equally use application program 3 115 as if application program 3 115 is executed in the user terminal 110 through a virtualization service. To this end, during the driving of application program 3 115 in the virtual machine of the server 150, input information input to the user terminal 110 for application program 3 115 may be transmitted to the server 150 through the network 130. Application program 3 115 driven in the virtual machine of the server 150 may receive and process the input information transmitted to the server 150 through the network 130. Otherwise, output information to be output through a display device or another output device may be transmitted to the user terminal 110 through the network 130 during the driving of application program 3 115 in the virtual machine of the server 150. The user terminal 110 may output the output information transmitted from the server 150 through the display device or another output device connected with the user terminal 110. Accordingly, application program 3 115 is actually executed in the virtual machine of the server 150, but the user may achieve the same effect as if application program 3 115 is executed in the user terminal 110 through the aforementioned process.

The present invention may lease only the virtual machine, that is, a hardware resource, from the server 150 of a cloud center, and use the operating system and the application program installed in the user terminal 110, differently from an existing Virtual Device Interface (VDI) service. Only the application program designated by the user is executed in the virtual machine of the server 150 and the output information about the corresponding application program is output through the display device or the output device connected to the user terminal 110, so that the user may be enabled to use the application program through the same interface as that used in the user terminal 110.

According to the present invention, the virtual machine operated in the server 150 uses the operating system or the software stored in the user terminal 110, so that the application program may be driven in the same environment as that in which the application program is executed in the user terminal 110.

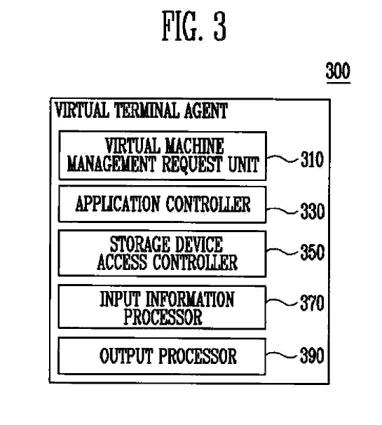

FIG. 2 is a block diagram illustrating an application program virtualization system according to an exemplary embodiment of the present invention in detail.

Referring to FIG. 2, an application program virtualization system 200 according to an exemplary embodiment of the present invention includes a user terminal 230, a server 250, and a display device 210. The display device is connected with the user terminal 230. Similar to the illustration of FIG. 1, the user terminal 230 and the server 250 are connected with each other through a network, but illustration of the network is omitted in FIG. 2. Further, in the description below, a process or procedure generally performed in the virtual desktop infrastructure or the cloud server is omitted.

In general, when the user terminal 230 executes the application programs, the user terminal 230 drives an operating system 237 stored in a storage device 239 inside the user terminal 230, and then loads and drives application program software stored in the storage device 239 again. However, in a case where performance of the user terminal 230 is insufficient, and a plurality of application programs is executed, the plurality of application programs may not be smoothly executed. In this case, as described above with reference to FIG. 1, the specific application program may be executed by a virtual machine 251 of the server 250 according to selection inside the user terminal 230 or selection of a user. In the example illustrated in FIG. 2, application program 3 252 is selected to be executed in the virtual machine 251. Hereinafter, the application program virtualization system 200 according to the present invention will be described together with a description of each constituent element.

The user terminal 230 may include a virtual terminal agent 231. Further, the user terminal 230 may execute application programs 233 and 235 by driving the operating system 237. In an exemplary embodiment, the virtual terminal agent 231 may be configured as a separate device included inside the user terminal 230. In this case, the virtual terminal agent 231 may be implemented by a semiconductor device, such as a micro processor and a central processor, and may be configured as a device separate from a device driving the operating system 237, application program 1 233, and application program 2 235. In another exemplary embodiment, the virtual terminal agent 231 may be implemented by a device operating the operating system 237, application program 1 233, and application program 2 235. For example, one central processor may drive the operating system, and application program 1 233, application program 2 235, and the virtual terminal agent 231 may be drive under the operating system. The virtual terminal agent 231 may enable application program 3 252 to be executed in the virtual machine 251 by communicating with the virtual machine 251 of the server 250 within the user terminal 230.

The user terminal 230 may include the operating system 237, and the plurality of application programs 233, 235, and 252. To this end, the storage device 239 of the user terminal 230 may store data for installing and executing the operating system 237 to be executed in the user terminal 230, and files for installing and executing the application programs 233, 235, and 252. The storage device 239 may be implemented by various devices, such as a Hard Disk Drive (HDD) and a Solid State Drive (HDD).

When the user terminal 230 needs to execute the application program through the virtual machine 251, the virtual terminal agent 231 may be configured to transmit data related to the operating system 237 and data related to the application program. For example, as illustrated in FIG. 2, when the user terminal 230 desires to directly execute application program 1 233 and application program 2 235, and execute application program 3 252 in the virtual machine 252 due to a lack of the resource, the virtual terminal agent 231 may transmit execution files of the operating system 237 stored in the storage device 239 and execution files of application program 3 252 to the server 250. Accordingly, according to the exemplary embodiment of the present invention, the virtual machine 251 operated in the server 250 may be allowed to use the operating system and the application program software included in the user terminal 230 as they are, so that the virtual machine 251 may execute application program 3 252 in the same environment as that in which application 3 252 is executed in the user terminal 230.

In the exemplary embodiment illustrated in FIG. 2, it is illustrated that the data related to the operating system 237 and application program 3 252 is stored in the single storage device 239. According to the exemplary embodiment, the user terminal 230 may include a plurality of storage devices, and in a case where the data related to the operating system 237 and application program 3 252 is divided and stored in the plurality of storage devices, the virtual terminal agent 231 may access all of the plurality of storage devices and relay the data to the server 250.

The display device 210 is connected with the user terminal 230. In FIG. 2, for convenience of illustration, it is illustrated that the user terminal 230 is separately configured from the display device 210, but the user terminal may be included in the display device, and may be integrally implemented with the display device according to the exemplary embodiment. Further, although not illustrated in FIG. 2, an input device, such as a key board or a mouse, for an input of the user may be connected to the user terminal 230. According to an operation of the user, the display device 210 may all or a part of the application programs 233 and 235 executed in the user terminal 230. For example, the display device 210 may process output information output from application program 1 233 and displays the processed output information on a display area 211 of application program 1 233, and process output information output from application program 2 235 and displays the processed output information on a display area 213 of application program 2 235. Further, in the application program virtualization system 200 according to the exemplary embodiment of the present invention, the display device 210 may display output information received from application program 3 252 executed by the virtual machine 251 driven in the server 250 in a display area 215 of application program 3 252. According to the exemplary embodiment, the display device 210 may display all of the screen images related to the operating system 254 and application program 3 252 driven in the virtual machine 251, and may also display only a screen image indicating only application program 3 252.

As described above, the input information for driving application program 3 252 is input by the same method as that of the input information for driving application programs 1 and 2 233 and 235, and the output information received from application program 3 252 is displayed or output by the same method as that of the input information for driving application programs 1 and 2 233 and 235, so that the user may use application program 3 252 without a difference from a case in which application program 3 252 is executed in the user terminal 230, and leases an insufficient resource from the server 250, thereby improving performance of the user terminal 230.

The server 250 may be at least a part of the cloud center or the virtual desktop infrastructure system. The server 250 may include a hypervisor 253, and the hypervisor 253 may boot the virtual machine based on the data related to the operating system 254 transmitted from the virtual machine of the user terminal 230. Further, the hypervisor 253 may make the virtual machine 231 execute application program 3 252 based on the data related to application program 3 252 transmitted from the virtual machine 231 of the user terminal 230.

The virtual machine 251 may be booted based on data related from the hypervisor 253, and execute application program 3 252. The data for driving application program 3 252 among the data input by the input device connected with the user terminal 230 may be transmitted to application program 3 252 executed in the virtual machine 251 of the server 250 through the network by the virtual terminal agent 231, and application program 3 252 may be operated based on the input data. The data output according to the operation of application program 3 252 may be transmitted to the virtual terminal agent 231 of the user terminal 230 through the network, and the virtual terminal agent 231 may transmit the output data to the display device 210 and output the output data in the display area 215 of application program 3.

A Cloud Data Center (CDC) management unit 255 may control the virtual machine 251 of the server 250. Although not illustrated in FIG. 2, the server 250 may drive a plurality of virtual machines, and a virtual machine management unit 256 of the CDC management unit 255 may control driving of the plurality of virtual machines. For example, in an exemplary embodiment, in a case where a plurality of user terminals connected to the server 250 makes a request for generation of a virtual machine, the requests may be received by the virtual machine management unit 256 of the CDC management unit 255, and the requested virtual machines may be generated and operated under control of the virtual machine management unit 256. Further, when the driving of the virtual machines is completed, so that the user terminals make requests for termination of the virtual machines, the virtual machine management unit 256 may delete or terminate the corresponding virtual machine in response to the request.

FIG. 3 is a block diagram illustrating a virtual terminal agent according to the exemplary embodiment of the present invention.

Referring to FIG. 3, a virtual terminal agent 300 according to the exemplary embodiment of the present invention includes a virtual machine management requesting unit 310, an application controller 330, a storage device access controller 350, an input information processor 370, and an output processor 390.

The virtual machine management requesting unit 310 may perform a function of making a request for generation or deletion of a virtual machine to a server side (a CDC or VDI center) according to a request of a user or a determination within the user terminal. A private network may directly access a hypervisor API by the request of the virtual machine management requesting unit 310 to perform the request. In the example of FIG. 2, the virtual machine management unit 310 may transmit the requests to the virtual machine management unit 255 of the CDC management unit 255.

The application controller 330 may serve to execute and control an application program designated to be operated in the virtual machine.

The storage device access controller 350 may serve to relay the storage device 239 so as to allow the storage device 239 to access. The storage device access controller 350 may serve to separately manage cache, operation information, and the like generated while the user terminal and the virtual machine are simultaneously operated to prevent a collision. In another exemplary embodiment of the present invention, the storage device access controller 350 may additionally adopt a method of caching information about the storage device of the user as a method of improving a situation in which image transmission of the operating system is not smooth or improving efficiency. In this case, the user may reduce a transmission process of the operating system during the access in the future.

The input information processor 370 may identify an input related to the application program executed in the virtual machine, transmit the identified input to the virtual machine, and make the virtual machine apply the transmitted input to the executed application program. In the example of FIG. 2, a plurality of elements of data is input through the input device connected with the user terminal 230, and the input information processor 370 may identify the input data for driving application program 3 252 among the input data and transmit the identified data to the server 250 side. The input data transmitted to the server 250 may be input to application program 3 252 to be processed.

The output processor 390 serves to receive a screen image of the virtual machine and make only a screen image of a corresponding application program be output on the display device or the output device of the terminal. In this case, the output device may be an audio device, a printer, and the like as well as a screen. For example, in the example of FIG. 2, the data output from application program 3 252 is transmitted to the virtual terminal agent 231 of the user terminal 230 through the network, and in this case, the output processor 390 may transmit the received output data to the display device 210 and make the transmitted output data be output on the display area 215 of application program 3.

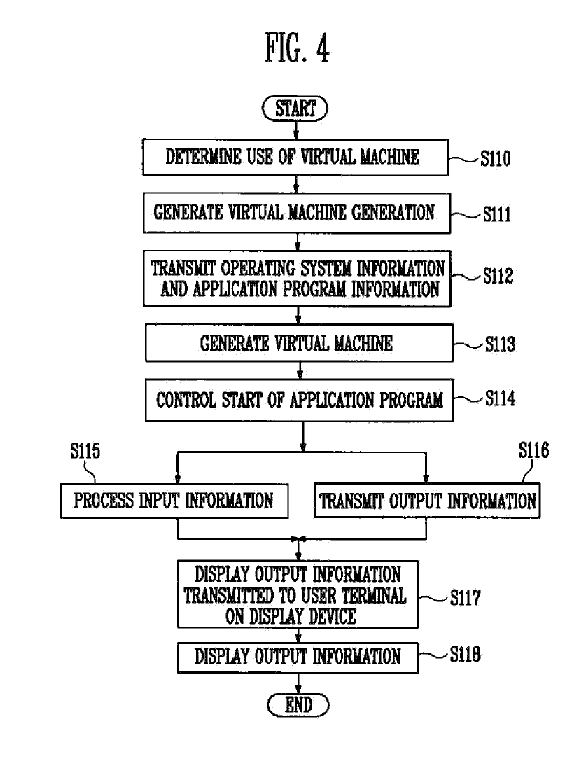

FIG. 4 is a flowchart illustrating an example of an application program virtualization method according to the present invention.

Referring to FIG. 4, the application program virtualization method according to the present invention includes step S110 of determining a use of a virtual machine, step Sill of making a request for generation of a virtual machine, step S112 of transmitting information about an operating system and information about an application program, step S113 of generating a virtual machine, step S114 of controlling a start of the application program, step S115 of processing input information, step S116 of processing output information, step of terminating the application program, and step S118 of terminating the virtual machine.

Step S110 of determining the use of the virtual machine may be performed by the user terminal as described with reference to FIG. 2. This process may be performed by a virtual machine use determination input input by the user, or by an internal determination of the user terminal. When the process is performed by the virtual machine use determination input input by the user, whether to use the virtual machine may depend on an arbitrary determination of the user of the user terminal. For example, in a case where the user recognizes that it is necessary to execute a specific application program through the virtual machine separately from an actual resource condition of the actual terminal, the use of the virtual machine may be determined through the input device connected with the user terminal. In another exemplary embodiment, for example, in a case where the resource of the user terminal is measured to be insufficient, the user terminal may determine the use of the virtual machine for itself.

Step S111 of making the request for the generation of the virtual machine may be performed by a method of transmitting a generation request message of the virtual machine from the user terminal to the server as described above. Particularly, step S111 of making the request for the generation of the virtual machine may be performed by a method of transmitting the virtual machine generation request message to the CDC management unit 255 of FIG. 2 by the virtual machine management request unit 310 of FIG. 3.

Step S112 of transmitting the information about the operating system and the information about the application program may be performed by the user terminal. In an exemplary embodiment, step S112 may be performed by a method of transmitting execution files of the operating system stored in the storage device 239 and execution files of application program 3 252 to the server by the virtual terminal agent 231 as illustrated in the drawing of FIG. 2. In this case, the information about the operating system may be the execution files of the operating system, and the information about the application program may be the execution files of the application program.

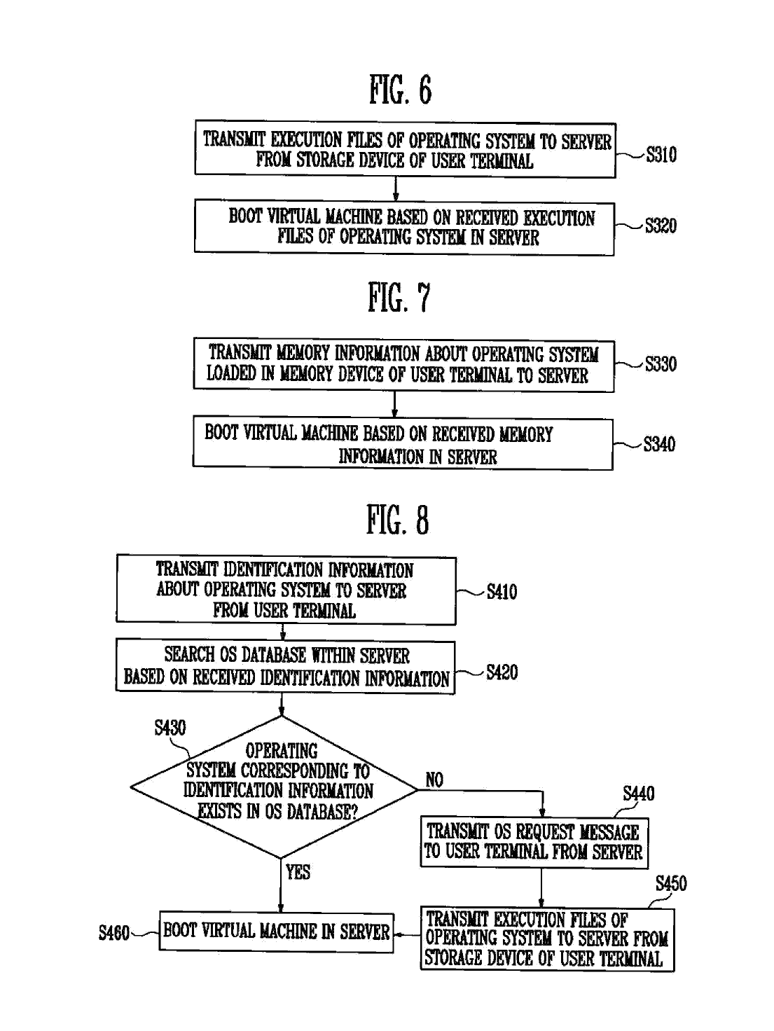

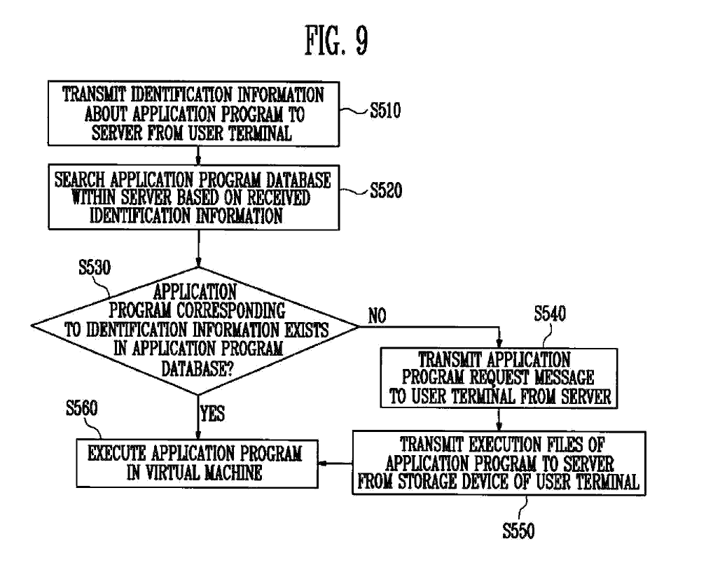

In another exemplary embodiment, the information about the operating system may be memory information about the operating system loaded in the memory device of the user terminal. The exemplary embodiment related to this will be described in more detail with reference to FIGS. 7 to 10 below. Further, the information about the operating system may be identification information about the operating system. The exemplary embodiment related to this will be described in more detail with reference to FIGS. 8, 9, and 12 below. In the meantime, the information about the application program may be identification about the application program.

Step S113 of generating the virtual machine may be performed in the server. As described above, step S113 may be performed in the CDC management unit 255 of FIG. 2, particularly, the virtual machine management unit 256. The virtual machine may be booted based on the information about the operating system transmitted in step S112. Further, in the exemplary embodiment of FIG. 4, it is illustrated that the transmission of the information about the application program is performed before the generation of the virtual machine for convenience, but the information about the application program may be transmitted after the generation of the virtual machine.

Step S114 of controlling the start of the application program may be performed by the virtual machine. The virtual machine may execute the application program based on the information about the application program received in step S112.

In step S115 of processing the input information, the input information processor included in the virtual terminal agent of the user terminal may identify information for the application program executed in the virtual machine among the information input through the input device connected with the user terminal and transmit the identified information to the server. The input information received in the server is transmitted to the application program of the virtual machine and processed by the application program.

In step S116 of processing the output information, the virtual machine of the server transmits output information output from the application program to the user terminal through the network. The output processor included in the virtual terminal agent of the user terminal may transmit the received output information to the display device, and make an indication related to the application program, which is currently executed in the virtual machine, be outputted.

Step S115 of processing the input information may be performed in parallel during the execution of the application program in the virtual machine.

Step S117 of terminating the application program may be performed by a request of the user terminal. For example, in a case where the virtual terminal agent of the user terminal receives a direction of terminating the application program, which is currently executed in the virtual machine, the virtual terminal agent may transmit an application program termination request to the virtual machine of the server.

Step S118 of terminating the virtual machine may be performed by a request of the user terminal. For example, a virtual machine termination request may be input to the user terminal through the input device by an arbitrary determination of the user using the user terminal, and the virtual terminal agent may process the virtual machine termination request and transmit the processed virtual machine termination request to the CDC management unit of the server. The CDC management unit may terminate or delete the generated virtual machine in response to the virtual machine termination request. In another exemplary embodiment, the virtual machine termination request may be transmitted by an internal determination of the user terminal. For example, the resource condition of the user terminal is improved due to termination of other application programs, and the like, or when the application program, which was being executed in the virtual machine, is already terminated, so that it is not necessary to drive the virtual machine any longer, the user terminal may internally determine to make a request for termination of the virtual machine regardless of the determination of the user. Otherwise, when the driving of the user terminal is terminated by the user, a message making for a request for termination of the virtual machine related to the user terminal may be sent as one of the termination procedures of the user terminal.

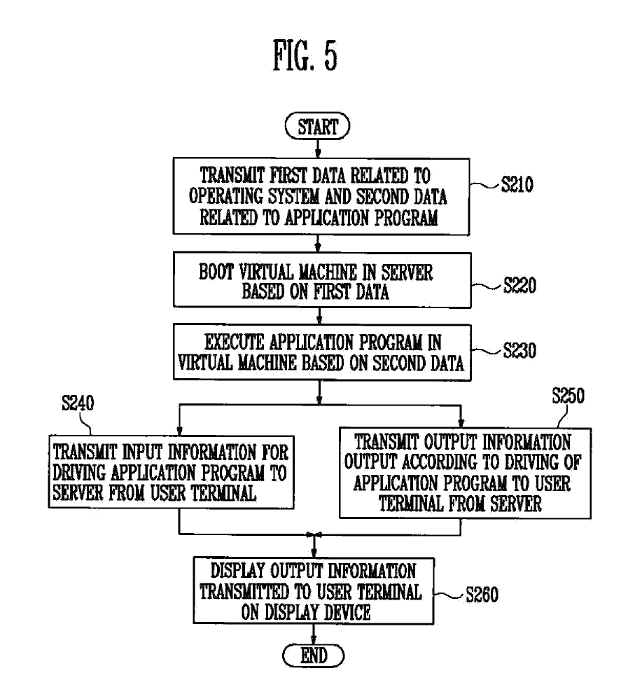

FIG. 5 is a flowchart illustrating another example of the application program virtualization method according to the present invention. Referring to FIG. 5, the application program virtualization method according to the present invention includes: step S210 of transmitting first data related to an operating system and second data related to an application program to the server, step S220 of booting a virtual machine based on the first data in the server, step S230 of executing an application program based on the second data in the virtual machine, step S240 of transmitting input information for driving the application program from the user terminal to the server, step S250 of transmitting output information output according to driving of the application program from the server to the user terminal, and step S260 of displaying the output information transmitted to the user terminal on the display device.

Step S210 of transmitting first data related to the operating system and second data related to the application program to the server may be performed by the user terminal as described above. In the exemplary embodiment, step S210 may be performed by a method of transmitting execution files of the operating system and execution files of application program 3 252 stored in the storage device 239 to the server by the virtual terminal agent 231 as illustrated in FIG. 2. In this case, the first data may be the execution files of the operating system, and the information related to the application program may be the execution files of the application program. Further, in other exemplary embodiments, the first data may be memory information about the operating system loaded in the memory device of the user terminal, and identification information about the operating system.

Step 220 of booting the virtual machine in the server based on the first data may be performed in the server. In the exemplary embodiment, step S220 may be performed by the hypervisor. In the exemplary embodiment, when the first data is the execution files of the operating system, the virtual machine generated by the hypervisor of the server may be booted based on the execution files of the operating system transmitted to the server. When the first data is the memory information about the operating system loaded in the memory device of the user terminal, the virtual machine generated by the hypervisor of the server may be booted based on the memory information received in the server. This will be described below with reference to FIGS. 7 to 10. In a case where the first data is the identification information about the operating system, the virtual machine may be booted by using the operating system stored in an OS database within the server. This will be described below with reference to FIGS. 8 to 12.

Step S230 of executing the application program based on the second data in the virtual machine may be performed after the booting of the virtual machine. In the exemplary embodiment, the second data may be the execution files of the application program. When the second data is the execution files of the application program, the virtual machine may execute the application program based on the execution files of the application received in the server. In another exemplary embodiment, the second data may be the identification information about the application program. In this case, the application program may be executed by using the application program stored in an application program database of the server. This will be described below with reference to FIGS. 9 to 12.

In step S240 of transmitting the input information for driving the application program from the user terminal to the server, the input information processor included in the virtual terminal agent of the user terminal may identify information for the application program executed in the virtual machine among the information input through the input device connected with the user terminal and transmit the identified information to the server. The input information received in the server is transmitted to the application program of the virtual machine and processed by the application program.

In step S250 of transmitting the output information output according to the driving of the application program from the server to the user terminal, the virtual machine of the server transmits the output information output from the application program to the user terminal through the network. The output processor included in the virtual terminal agent of the user terminal transmits the received output information to the display device, and makes an indication related to the application program currently executed in the virtual machine be output.

Step S240 of transmitting the input information for the driving of the application program from the user terminal to the server, and step S250 of transmitting the output information output according to the driving of the application program from the server to the user terminal may be performed in parallel during the execution of the application program.

In step S260 of displaying the output information transmitted to the user terminal on the display device, the output processor of the virtual terminal agent may process the output information received from the server and transmit the processed output information to the display device. The display device may display the received output information on at least a partial area of the display device. FIG. 5 illustrates that step S260 of displaying the output information is performed after step S240 of transmitting the input information to the server and step S250 of transmitting the output information to the user terminal, but are not limited thereto, and step S260 may be performed in parallel with step S240 and step S250 during the execution of the application program.

FIG. 6 is a flowchart illustrating the step of booting the virtual machine based on the operating system of the user terminal according to the exemplary embodiment of the application program virtualization method according to the present invention.

The exemplary embodiment of FIG. 6 limits and specifies step S210 and step S220 in the method of FIG. 5. In the exemplary embodiment of FIG. 6, the first data is the execution files of the operating system. Step S310 of transmitting the execution files of the operating system from the storage device of the user terminal to the server is performed by the user terminal. In step S310, the execution files of the operating system stored in the storage device within the user terminal are transmitted to the server by the storage device access controller of the virtual terminal agent. Step S320 of booting the virtual machine based on the execution files of the transmitted operating system in the server may be performed by the hypervisor.

FIG. 7 is a flowchart illustrating the step of booting the virtual machine based on the operating system of the user terminal according to another exemplary embodiment of the application program virtualization method according to the present invention.

The exemplary embodiment of FIG. 7 limits and specifies step S210 and step S220 in the method of FIG. 5. In the exemplary embodiment of FIG. 7, the first data is the memory information about the operating system loaded in the memory device of the user terminal. In this case, the virtual machine is not booted by fetching the execution files of the operating system stored in the storage device of the user terminal, but the memory information of the user terminal is moved to the server as it is, so that the virtual machine is booted. That is, step S330 of transmitting the memory information about the operating system loaded in the memory device of the user terminal to the server may be performed by the virtual terminal agent, and step S340 of booting the virtual machine based on the memory information received in the server may be performed by the hypervisor.

FIG. 8 is a flowchart illustrating the step of booting the virtual machine based on the operating system of the user terminal according to yet another exemplary embodiment of the application program virtualization method according to the present invention.

Referring to FIG. 8, the method of booting the virtual machine according to the exemplary embodiment of the present invention includes step S410 of transmitting identification information about the operating system to the server from the user terminal, step S420 of searching the OS database within the server based on the received identification information, step S430 of determining whether an operating system corresponding to the identification information exists in the OS database, step S440 of transmitting an OS request message to the user terminal from the server when the operating system does not exist, step S450 of transmitting execution files of the operating system to the server from the storage device of the user terminal, and step S460 of booting the virtual machine in the server.

In the exemplary embodiment of FIG. 8, the first data is the identification information about the operating system. The identification information about the operating system may include a name, a manufacturing company, a version, and a serial number of the operating system, and the like. When the server equally possesses the operating system possessed by the user terminal, the rent of even the operating system necessary for the virtual machine of the server requires an additional cost, and the transmission of the execution files to the server from the user terminal for the decrease in the rent cost causes a traffic and makes rapid use of the virtual machine be difficult. Accordingly, when the server equally possesses the operating system possessed by the user terminal, a license problem may be solved through the transmission of the identification number, and the virtual machine may be immediately booted based on the operating system of the server.

FIG. 9 is a flowchart illustrating the step of executing the application program on the virtual machine according to an exemplary embodiment of the application program virtualization method according to the present invention.

Referring to FIG. 9, the method of executing the application program according to the exemplary embodiment of the present invention includes step S510 of transmitting the identification information about the application program to the server from the user terminal, step S520 of searching the application program database within the server based on the received identification information, step S530 of determining whether an application program corresponding to the identification information exists in the application program database, step S540 of transmitting an application program request message to the user terminal from the server when the application program does not exist, step S550 of transmitting execution files of the application program to the server from the storage device of the user terminal, and step S560 of executing the application in the virtual machine.

In the exemplary embodiment of FIG. 9, the first data is the identification information about the application program. The identification information about the application program may include a name, a manufacturing company, a version, and a serial number of the application program, and the like. When the server equally possesses the application program possessed by the user terminal, the rent of even the application program to be executed by the virtual machine of the server requires an additional cost, and the transmission of the execution files of the application program to the server from the user terminal for the decrease in the rent cost causes a traffic and makes rapid use of the application program be difficult. Accordingly, when the server equally possesses the application program possessed by the user terminal, a license problem may be solved through the transmission of the identification number, and the application program of the server may be immediately executed.

FIG. 10 is a block diagram illustrating an application program virtualization system according to another exemplary embodiment of the present invention.

Referring to FIG. 10, an application program virtualization system 400 according to another exemplary embodiment of the present invention includes a user terminal 430, a server 450, and a display device 410. The display device 410 is connected with the user terminal 430. The display device includes display areas 411, 413, and 415 of the application programs. In the exemplary embodiment of FIG. 10, similar to the exemplary embodiment of FIG. 2, application program 1 433 and application program 2 435 are executed in the user terminal 430, and application program 3 452 are executed in the server 450. Application program 1 433 and application program 2 435 may be executed under the operating system 437. Further, the user terminal 430 includes a storage device 438 and a memory 439. In the meantime, a virtual machine 451 may be generated and terminated by a virtual machine management unit 456 of, a CDC management unit 455. Further, the virtual machine 451 may be booted by a hypervisor 453.

The exemplary embodiment of FIG. 10 is different from the exemplary embodiment of FIG. 2 in that a virtual terminal agent 431 transmits memory information about an operating system loaded in the memory 439 to the server 450. In the exemplary embodiment of FIG. 10, the virtual machine is not booted by fetching the execution files of the operating system stored in the storage device 438 of the user terminal 430, but the virtual machine is booted by moving the information loaded in the memory 439 of the user terminal 430 to the server 430 as it is. The hypervisor 453 may boot the virtual machine 451 based on information about the memory 439 transmitted to the server.

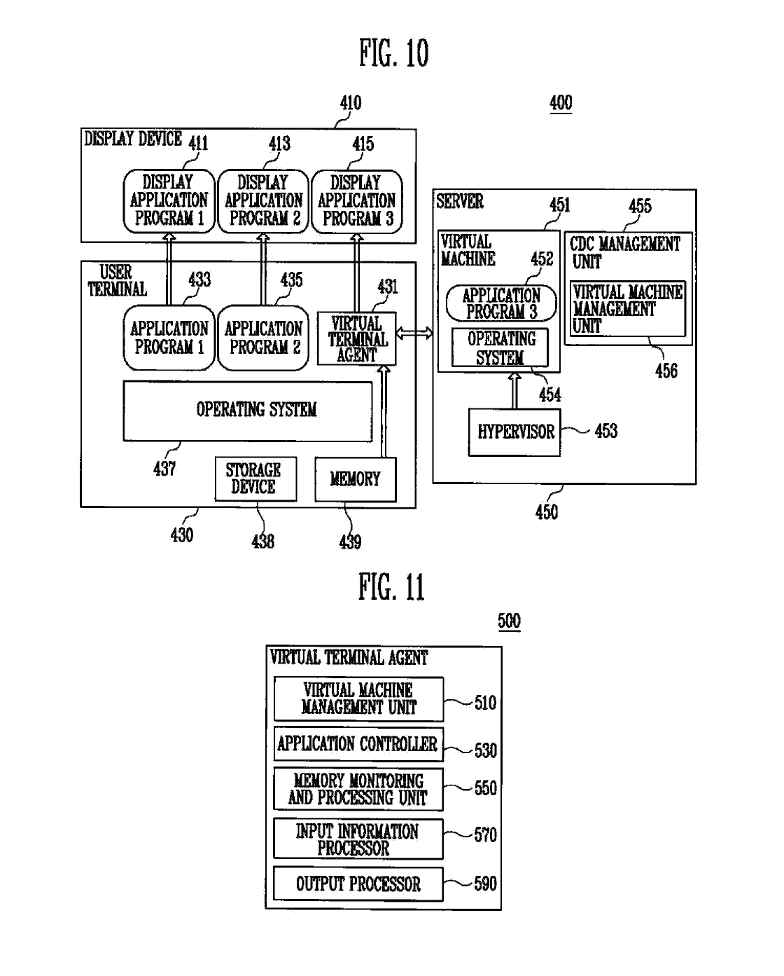

FIG. 11 is a block diagram illustrating the virtual terminal agent according to another exemplary embodiment of the present invention. The virtual terminal agent 431 of FIG. 10 may be implemented by a virtual terminal agent 500 of FIG. 11. The virtual terminal agent 500 of FIG. 11 includes a virtual machine management request unit 510, an application controller 530, a memory monitoring and processing unit 550, an input information processor 570, and an output processor 590. A configuration of the virtual terminal agent 500 of FIG. 11 is similar to that of the virtual terminal agent 300 of FIG. 3, but includes the memory monitoring and processing unit 550 instead of the storage device access controller 350 of FIG. 3.

The memory monitoring and processing unit 550 may monitor the memory 439 of the user terminal 430. In the exemplary embodiment of FIG. 10, the virtual machine is not booted by fetching the execution files of the operating system stored in the storage device 438 of the user terminal 430, but the virtual machine 451 is booted by moving the information loaded in the memory 439 of the user terminal 430 to the server 450 as it is. Accordingly, in the exemplary embodiment of FIG. 10, a changed matter of the memory 439 may need to be reflected to the virtual machine 451 of the server 450 in real time. The memory monitoring and processing unit 550 of FIG. 11 may monitor the memory 439 of the user terminal 430 and transmit related data to the server 450 in order to reflect the changed matter to the virtual machine 451 of the server 450.

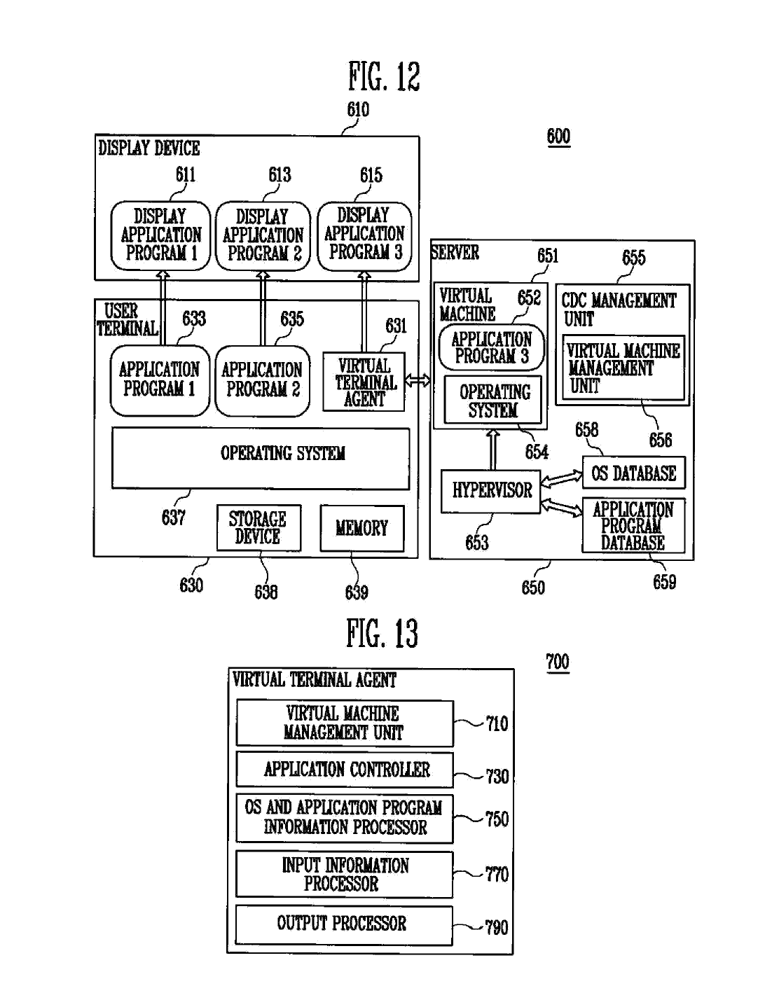

FIG. 12 is a block diagram illustrating an application program virtualization system according to yet another exemplary embodiment of the present invention.

Referring to FIG. 12, an application program virtualization system 600 according to yet another exemplary embodiment of the present invention includes a user terminal 630, a server 650, and a display device 610. The display device 610 is connected with the user terminal 630. The display device 610 includes display areas 611, 613, and 615 of the application programs. In the exemplary embodiment of FIG. 12, similar to the exemplary embodiment of FIG. 2, application program 1 633 and application program 2 635 are executed in the user terminal 633, and application program 3 652 are executed in the server 650. Application program 1 633 and application program 2 635 may be executed under an operating system 637. Further, the user terminal 630 includes a storage device 638 and a memory 639. In the meantime, a virtual machine 651 may be generated and terminated by a virtual machine management unit 656 of a CDC management unit 655. Further, the virtual machine 651 may be booted by a hypervisor 651.

The exemplary embodiment of FIG. 12 is different from the exemplary embodiment of FIGS. 2 and 10 in that a virtual terminal agent 631 transmits identification information about the operating system 637 and identification program about an application program 654 to the server 450. In the exemplary embodiment of FIG. 12, the virtual machine is not booted by fetching the execution files of the operating system stored in the storage device 638 of the user terminal 630, or by transmitting the information loaded in the memory 639 of the user terminal 630 to the server 650, but the virtual machine is booted by the operating system stored in an OS database 658 based on the identification information about the operating system transmitted from the user terminal 630. A hypervisor 653 may boot the virtual machine 651 based on information about the memory 639 transmitted to the server 650.

As described with reference to FIG. 8, the identification information about the operating system may include a name, a manufacturing company, a version, and a serial number of the operating system, and the like. When the server 650 equally possesses the operating system possessed by the user terminal 630, the rent of even the operating system 654 necessary for the virtual machine 651 of the server 650 requires an additional cost, and the transmission of the execution files of the operating system to the server from the user terminal 630 for the decrease in the rent cost causes a traffic and makes rapid use of the virtual machine be difficult. Accordingly, when the server 650 equally possesses the operating system 637 possessed by the user terminal 630, a license problem may be solved through the transmission of the identification number, and the virtual machine 651 may be immediately booted based on the operating system of the server 650. The identification information about the operating system 637 is transmitted to the server 650 by the virtual terminal agent 631, and the hypervisor 653 searches an OS database 658 based on the received identification information. When the corresponding operating system is stored in the OS database 658, the virtual machine 651 may be booted based on the operating system. When the corresponding operating system is not stored in the OS database 658, as illustrated in FIG. 8, the server 650 may transmit an OS request message to the user terminal 630, and the user terminal 630 may transmit the execution files of the operating system stored in the storage device 638 to the server 650.

Further, identification information about application program 3 652 may include a name, a manufacturing company, a version, and a serial number of the application program, and the like. When the server 650 equally possesses application program 3 652 possessed by the user terminal 630, the rent of even application program 3 652 to be executed in the virtual machine 651 of the server 650 requires an additional cost, and the transmission of the execution files of application program 3 652 to the server 650 from the user terminal 630 for the decrease in the rent cost causes a traffic and makes rapid use of the virtual machine be difficult. Accordingly, when the server 650 equally possesses application program 3 652 possessed by the user terminal 630, a license problem may be solved through the transmission of the identification number, and application program 3 652 of the server 650 may be immediately executed. The identification information about application program 3 652 is transmitted to the server 650 by the virtual terminal agent 631, and the hypervisor 653 searches an application program database 659 based on the received identification information. When corresponding application program 3 652 is stored in the application program database 659, application program 3 652 may be directly executed in the virtual machine 651. When corresponding application program 3 652 is not stored in the application program database 659, as illustrated in FIG. 9, the server 650 may transmit an application program request message to the user terminal 630, and the user terminal 630 may transmit the execution files of application program 3 652 stored in the storage device 638 to the server 650.

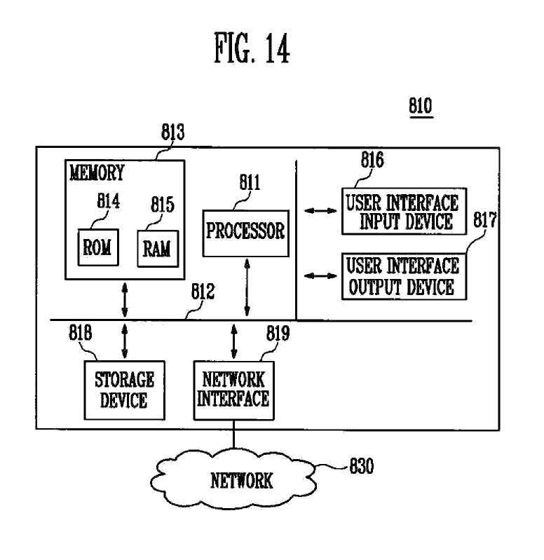

FIG. 13 is a block diagram illustrating a virtual terminal agent according to yet another exemplary embodiment of the present invention.

The virtual terminal agent 631 of FIG. 12 may be implemented by a virtual terminal agent 700 of FIG. 13. The virtual terminal agent 700 of FIG. 13 includes a virtual machine management request unit 710, an application controller 730, an OS and application program information processor 750, an input information processor 770, and an output processor 790. A configuration of the virtual terminal agent 700 of FIG. 13 is similar to that of the virtual terminal agent 300 of FIG. 3, but includes the OS and application program information processor 750 instead of the storage device access controller 350 of FIG. 3. The OS and application program information processor 750 may process the identification information about the operating system 637 of the user terminal 630, or the identification information about application program 3 654 and transmit the processed identification information to the server 650.

According to the exemplary embodiment, as described with reference to FIG. 12, when corresponding software does not exist in the OS database and the application program database, the user terminal needs to directly transmit the execution files of the operating system or the application program, so that the virtual terminal agent 700 of FIG. 13 may further include the storage device access controller 350 of FIG. 3 or the memory monitoring and processing unit 550 of FIG. 11 in addition to the OS and application program information processor 750.

FIG. 14 is a block diagram illustrating a computer system for implementing the exemplary embodiments of the application program virtualization system according to the present invention.

As illustrated in FIG. 14, the user terminal or the server according to the exemplary embodiment of the present invention may be implemented by the computer system. The computer system 810 may include one or more processors 811 communicating with each other through a bus 812, a memory 813, a user interface input device 816, a user interface output device 817, a network interface 819, and a storage device 818. The processor 811 may be a Central Processor (CPU) or a semiconductor device executing processing commands stored in the memory 813 or the storage device 818. The memory 813 and the storage device 818 may include various types of volatile or nonvolatile storage medium. For example, the memory 813 may include a Read Only Memory 814 and a Random Access Memory 815. The computer system 810 may be connected to an external network 830 through the network interface 819.

Accordingly, the application program virtualization method of the user terminal according to the exemplary embodiment of the present invention may be implemented by a computer executable method. For the implementation of the computer executable method, computer executable commands may be stored in a computer readable storage medium in coded forms. In the exemplary embodiment, the computer executable commands may be executed by the processor 121 and perform the method according to at least one aspect of the present invention.

Depending on the implementation, the user terminal may be implemented by one of various computer systems, such as a personal computer, a Ultra mobile PC (UMPC), a work station, a net book computer, Personal Digital Assistants, a portable computer, a web tablet computer, a wireless phone, a mobile phone, a smart phone, an e-book reader, a Portable Multimedia Player (PMP), a portable game player, a navigation device, a black box, a digital camera, a 3-dimensional television, a digital audio recorder, a digital audio player, a digital picture recorder, a digital picture player, a digital video recorder, a digital video player, a device capable of transceiving information in a wireless environment.

The detailed description of the present invention includes the description of the particular exemplary embodiments, but various modifications are available within the scope without departing from the scope and the technical spirit of the present invention. Particularly, those skilled in the art will appreciate that the respective bocks of the processing flowcharts, and combinations of the flowchart drawings may be performed by compute program instructions. The computer program instructions may be mounted in a process of a general purpose computer, a specialized computer, or other programmable data processing equipment, and the instructions performed through the processor of the computer or other programmable data processing equipment generate means performing the functions described in the blocks of the flowcharts. In order to implement a function by a specific method, the computer program instructions may use the computer or a computer aiming other programmable data processing equipment, or may be stored in a computer readable memory, so that the instructions using the computer or stored in the computer readable memory may product a manufactured item including an instruction means performing the function described in the flowchart block(s). Since the computer program instructions may be mounted in the computer or other programmable data processing equipment, a series of operating steps is performed in the computer or other programmable data processing equipment to generate a computer executable process, so that the instructions performed in the computer or other programmable data processing equipment may provide the steps for executing the function described in the flowchart block(s).

Further, each block may represent a part of modules, segments, or codes including one or more executable instructions for executing specific logical functions. Further, it shall be noted that in several replaced execution examples, functions mentioned in the blocks may be generated without limiting to the order. For example, the subsequently illustrated two blocks may be substantially simultaneously performed in actual, or the blocks may be sometimes performed in a reverse order according to a corresponding function.

In this case, a term “˜ unit” used in the present exemplary embodiment means a software element or a hardware element, such as a Field Programmable Gate Array (FPGA) or (Application Specific Integrated Circuit) ASIC, and the term “˜ unit” serves specific functions. However, the term “˜ unit” is not limited to software or hardware. The term “˜ unit” may be configured to be present in an addressable storage medium, or to reproduce one or more processors. Accordingly, as an example, the term “˜ unit” includes elements, such as software elements, object-oriented software elements, class elements, and task elements, processes, functions, attributes, procedures, sub-routines, segments of a program code, drivers, firmware, a microcode, a circuit, data, a database, data structure, tables, arrays, and variables. The elements and the functions provided by the “˜ units” may be combined to the smaller number of elements and “˜ units”, or be further separated into additional elements and “˜ units”. In addition, the elements and “˜ units” may be implemented so as to reproduce one or more CPUs within a device or a supplement multimedia card.

As described above, the embodiment has been disclosed in the drawings and the specification. The specific terms used herein are for purposes of illustration, and do not limit the scope of the present invention defined in the claims. Accordingly, those skilled in the art will appreciate that various modifications and another equivalent example may be made without departing from the scope and spirit of the present disclosure. Therefore, the sole technical protection scope of the present invention will be defined by the technical spirit of the accompanying claims.

What is claimed is:

1. A system for virtualizing an application program, comprising:
a user terminal including an operating system and a plurality of application programs; and
a server configured to generate a virtual machine in response to a request of the user terminal, and
wherein the user terminal includes a virtual terminal agent configured to transmit first data related to the operating system and second data related to selected one or more application programs to the server, and
the server generates and boots a virtual machine based on the first data, and executes the selected one or more application programs in the virtual machine based on the second data.

2. The system of claim 1, wherein the virtual terminal agent includes:
a virtual machine management request unit configured to make a request for generation of the virtual machine for executing the selected one or more application programs;
a storage device access controller configured to transmit the first data and the second data to the server;
an application controller configured to control the application program executed in the virtual machine;
an input information processor configured to identify input to be transmitted to the application program executed in the virtual machine and transmit the identified input to the server; and
an output processor configured to receive and process an output generated by the application program from the virtual machine of the server.

3. The system of claim 2, wherein the first data are execution files of the operating system stored in the storage device of the user terminal, and the server boots the virtual machine based on the received execution files of the operating system.

4. The system of claim 2, wherein the first data is memory information about the operating system loaded in the storage device of the user terminal, and the server boots the virtual machine based on the received memory information.

5. The system of claim 4, wherein the virtual terminal agent further includes:
a memory monitoring unit configured to detect a changed matter of the memory device of the user terminal; and
a memory processor configured to transmit the detected changed matter to the virtual machine of the server.

6. The system of claim 2, wherein the first data is identification information about the operating system driven in the user terminal, and the server boots the virtual machine based on the operating system stored in the server based on the received identification information.

7. The system of claim 2, wherein the user terminal further includes a display device, and
the output processor displays a screen image transmitted from the virtual machine of the server on at least a part of the display device.

8. The system of claim 1, wherein the virtual terminal agent transmits the first data to a hypervisor of the server, and the hypervisor boots the virtual machine based on the received first data.

9. A user terminal, comprising:
a storage device configured to store an operating system and a plurality of application programs;
a virtual terminal agent configured to relay so as for one or more application programs among the plurality of application programs to be executed in a virtual machine of a server, and
a display device configured to display an output of an application program executed in the virtual machine,
wherein the virtual terminal agent transmits first data related to the operating system and second data related to an application program to be executed in the virtual machine to the server.

10. The user terminal of claim 9, further comprising:
one or more processors configured to execute application programs except for the application program executed in the virtual machine.

11. A method of virtualizing an application program of a user terminal, comprising:
transmitting first data related to an operating system stored in the user terminal and second data related to one or more application programs selected from among a plurality of application programs,
booting a virtual machine in the server based on the first data;
executing the selected one or more application programs in the virtual machine based on the second data; and
transmitting input information for driving the executed application program to the server from the user terminal, and transmitting output information output according to the driving of the executed application program to the user terminal from the server.

12. The method of claim 11, further comprising:
displaying the output information transmitted to the user terminal on at least a partial area of a display device of the user terminal.

13. The method of claim 11, wherein the first data are execution files of the operating system stored in the storage device of the user terminal, and the server boots the virtual machine based on the received execution files of the operating system.

14. The method of claim 11, wherein the first data is memory information about the operating system loaded in the storage device of the user terminal, and the server boots the virtual machine based on the received memory information.

15. The method of claim 11, wherein the first data is identification information about the operating system driven in the user terminal, and the server boots the virtual machine based on the operating system stored in the server based on the received identification information.

16. The method of claim 15, wherein the booting of the virtual machine in the server based on the first data includes:
searching an OS database within the server based on the identification information about the operating system; and
booting the virtual machine based on a result of the searching of the OS database.

17. The method of claim 16, wherein (i) when the operating system corresponding to the identification information is stored in the OS database as a result of the searching of the OS database, the server boots the virtual machine based on the operating system stored in the OS database, and
(ii) when the operating system corresponding to the identification information is not stored in the OS database as the result of the searching of the OS database, the server transmits an OS request message to the user terminal.

18. The method of claim 17, wherein the user terminal transmits the execution files of the operating system stored in the user terminal to the server in response to the OS request message.
